(19) United States
(12) Patent Application Publication
(10) Pub. No.: US 2013/0188351 A1
(43) Pub. Date: Jul. 25, 2013

(54) ILLUMINATION APPARATUS FOR GLARE-FREE ILLUMINATION, USE OF THE ILLUMINATION APPARATUS, METHOD AND ARRANGEMENT HAVING THE ILLUMINATION APPARTATUS

(71) Applicant: DIEHL AEROSPACE GMBH, Ueberlingen (DE)

(72) Inventor: Frank SCHMID, Poppenricht (DE)

(73) Assignee: DIEHL AEROSPACE GMBH, Ueberlingen (DE)

(21) Appl. No.: 13/744,640

(22) Filed: Jan. 18, 2013

(30) Foreign Application Priority Data
Jan. 21, 2012 (DE) 102012001142.3

(51) Int. Cl. F21V 9/00

(52) U.S. Cl. CPC F21V 9/00
USPC 362/235

(57) ABSTRACT

The invention is based on the object of proposing an improved illumination apparatus for glare-free illumination of an area monitored by a night vision device.

For this purpose, an illumination apparatus for glare-free illumination of an area monitored by a night vision device is proposed, the night vision device picking up light of wavelength greater than a limiting wavelength, having an illumination device which comprises at least one LED, the illumination device being designed to emit light with light fractions in the visible region, and having an optical filter device which is designed as an interference filter device, a transmission of the optical filter device being greater, in a visible wavelength region below the limiting wavelength, than 80%, preferably greater than 90% for the light of the illumination device in the visible wavelength region, and being less, in a red wavelength region above the limiting wavelength, than 1%, preferably less than 0.1% for the light of the illumination device in the red wavelength region.

### BACKGROUND OF THE INVENTION

The invention relates to an illumination apparatus for glare-free illumination of an area monitored by a night vision device, the night vision device picking up light of wavelength greater than a limiting wavelength, having an illumination device which comprises at least one LED, the illumination device being designed to emit light with light fractions in the visible region. The invention also relates to a use for the illumination apparatus, a method with the illumination apparatus, and an arrangement which likewise comprises the illumination apparatus.

### DISCUSSION OF THE PRIOR ART

In areas insufficiently illuminated for human eyes, night vision devices permit the production of contrast-rich images of the areas. The night vision devices frequently make use herefor of a wavelength band which lies above the wavelength band of visible light for the human eye. Here, it is possible, firstly, for the night vision devices to use existing residual light, in particular in said wavelength band, while secondly it is possible for the areas to be lit up actively by illumination, the used wavelength band of which likewise lies above the visible region for the human eye.

However, the technical challenge is frequently encountered that, firstly, a night vision device is to be used in one surroundings but secondly, however, areas of the surroundings are to be illuminated so that said areas can be perceived by a person with the naked eye, that is to say without night vision equipment. A typical field of application is that of aircraft illumination, parts of the interior of the aircraft being illuminated with light visible to humans, but pilots are supposed to use a night vision device. If customary illumination is used to illuminate the interior, said illumination would dazzle the night vision devices, that is to say override them.

Publication DE69907652T2, which largely constitutes the closest prior art, relates to an aircraft illumination apparatus compatible with a night vision system, the aim being to use said illumination apparatus jointly with a night vision device. It is proposed in this publication to use a white LED as illumination means for the illumination apparatus, the reason being that the light fractions of the white LED which can be perceived by the night vision device are so small that they can no longer cause interference.

### SUMMARY OF THE INVENTION

It is the object of the invention to propose an improved illumination apparatus for glare-free illumination of an area monitored by a night vision device.

This object is achieved by an illumination apparatus having the features of claim 1, by a use having the features of claim 12, by a method having the features of claim 13, and by an arrangement having the features of claim 14. Preferred or advantageous embodiments of the invention emerge from the subclaims, the following description and the attached figures.

Within the framework of the invention, an illumination apparatus is disclosed which is designed for glare-free illumination of an area monitored by a night vision device.

Within the scope of the invention, what is to be understood in particular by glare-free is that the illumination apparatus and the night vision device are compatible in operation in such a way that an interference-free overlap is possible between a field of view of the night vision device and of an illumination area of the illumination apparatus, and/or does not cause any blooming effect, overdriving and/or glare for the night vision device.

The area can be any desired area, for example a switching centre in a factory installation, etc., an interior of a vehicle, aircraft, etc. and, in particular, a cockpit of the aircraft. The area is monitored intentionally or unintentionally with the night vision device. It is therefore possible for the area illuminated by the illumination apparatus to come into the field of view of the night vision device unintentionally, and thereby be assigned to the monitored area.

The night vision device is an apparatus which enables or improves visual perception in areas which are in natural darkness or twilight. The English designation “Night Vision Imagine System” NVIS has also become accepted for such a night vision device. The night vision device utilizes wavelength regions which are outside or largely outside the visible spectrum. The night vision device is designed with particular preference as an attachment which is mounted by a user in order to monitor the area. The night vision device picks up only light of a wavelength greater than a nominal or actual limiting wavelength.

The illumination apparatus comprises an illumination device which has at least one LED, the illumination device being designed to emit light with light fractions in a visible wavelength region. A wavelength region of 400 nm to 700 nm is understood to be the visible wavelength region.

It is proposed according to the invention that upstream of the illumination device is an optical filter device which is designed as an interference filter device. Such interference filter devices are formed by optical layers of specific thickness on a substrate such as, for example, glass. The transmission of the interference filter device can be set with very high precision by the thickness of the optical layers.

The transmission of the optical filter device is set so that said transmission is greater, in a visible wavelength range below the limiting wavelength, that is to say in a wavelength range of 400 nm up to a limiting wavelength, than 80%, preferably greater than 90%, so that more than 80%, preferably more than 90% of the total light of the illumination device is passed in the visible wavelength range between 400 nm and the limiting wavelength. In a region, denoted as red wavelength region, above the limiting wavelength, the transmission is less than 1%, preferably less than 0.1% for the light of the illumination device in the red wavelength region. Consequently, less than 1%, preferably less than 0.1% is transmitted of the total light which is emitted by the illumination device above the limiting wavelength.

The red wavelength region is preferably defined as starting at 580 nm and finishing at 950 nm. Light of the illumination device which is greater in a wavelength region than the limiting wavelength and less than 950 nm, is therefore transmitted less than 1%, in particular less than 0.1%.

The invention takes into consideration in this case that the use of a very precisely operating optical filter device can substantially reduce, or even completely eliminate the interference of night vision devices by the illumination apparatus in the monitored area. The result of the described characteristic of the optical filter device is to minimize attenuation of the light of the illumination device, whereas the protection of the night vision device is optimized.

There is thus proposed an NVIS-compatible illumination apparatus which preferably conforms to the MIL-STD-3009 NVIS white and has a very high efficiency. The consumed power can be selected to be low owing to the high efficiency. As secondary effects, there is less heat loss and this, in turn, affects the size of the required heat sink and thus the weight of the illumination apparatus.

In a preferred embodiment of the invention, the optical filter device is designed as a short-pass filter, which transmits only wavelengths less than the limiting wavelength, and/or as an edge filter and/or as a dichroic mirror. It is ensured in all three embodiments named that the characteristic described at the beginning is achieved.

In a particularly preferred embodiment of the invention, the limiting wavelength is arranged in a region between 600 nm and 650 nm and, in particular, is 610 nm. The last named value constitutes the fulfilment of the specification with regard to the MIL-STD-3009.

In a possible embodiment of the invention, the optical filter device has a limiting wavelength band in which the transmission varies from the visible wavelength region to the transmission of the red wavelength region. In order to configure the illumination apparatus as effectively as possible, it is proposed that this limiting wavelength band is narrow so that the transmission curve has a steep edge. It is preferred that the limiting wavelength band is designed to be narrower than 20 nm, preferably narrower than 10 nm. The width of the limiting wavelength band is calculated at one end by the traversal of a 70% mark of the transmission curve, and at the other end by the traversal of the 2% mark of the transmission curve.

In a particularly preferred embodiment of the invention, it is proposed that the transmission of the optical filter device is always greater, in the visible wavelength region below the limiting wavelength or the limiting wavelength band, than 70%, and in particular always greater than 80%. This embodiment takes into account that in the case of real interference filter devices the transmission curve exhibits interference in the form of “ripples” or harmonics, the aim being that the transmission curve should not touch or intersect a limiting value curve at 70% or 80% despite this interference.

In the same way, it is optionally claimed in addition that the transmission of the optical filter device is always less, in the red wavelength region above the limiting wavelength or the limiting wavelength band, than 2%, in particular always less than 0.2%. In this range, as well, no or only slight interference is to be permitted in the transmission curve.

In a particularly preferred embodiment of the invention, the at least one LED is designed as a white LED—also known as white light LED. Such white LEDs comprise a UV or blue LED chip and a light-emitting layer or another converter layer which converts radiation of the UV or blue LED chip into light of a longer wavelength. The spectral distribution of the white LED is thereby characterized by a high peak in the range from, for example, 390 nm, and a relatively wide tail section with a maximum in a range from, for example, 550 nm. The optical filter device cuts off from the tail section the spectral component which is above the limiting wavelength. The white LED is preferably selected so that more than 60% of the light output of the white LED is smaller, in the visible wavelength region, than the limiting wavelength band and/or the limiting wavelength and/or less than 30% of the light output of the white LED is within the red wavelength region above the limiting wavelength band or the limiting wavelength.

In another embodiment of the invention, the illumination device has a plurality of LEDs which show different colours. By skilful selection of different colours of the LEDs, it is possible to achieve that the light component transmitted by the optical filter device can attain a very natural illumination of the area. In particular, it is achieved that the typical “night vision green” is avoided. It is proposed for this purpose that the illumination device has a green, a red and a white LED, which jointly emit the light with the colour components in the visible region.

In a preferred particular version of the invention, it is provided that the illumination apparatus is arranged in the area monitored by the night vision device, or in the area acquired by the field of view of the night vision device.

In one possible implementation of the invention, the illumination apparatus is designed as instrument lighting, as interior lighting, as onboard instrument lighting, as cockpit lighting and/or as a reading lamp, for example for an aircraft.

A further subject matter of the invention relates to the use of the illumination apparatus as has previously been described, or according to one of the preceding claims, said illumination apparatus being used in the area monitored by the night vision device. In particular, the illumination apparatus is used in the area simultaneously with the night vision device, the field of view of the night vision device and of the illumination area of the illumination apparatus overlapping.

A further subject matter of the invention relates to a method for glare-free illumination of an area monitored by a night vision device, the area monitored by the night vision device being illuminated by an illumination apparatus according to one of the preceding claims or as previously described.

A last subject matter relates to an arrangement which comprises a night vision device and an illumination apparatus according to one of the preceding claims or as previously described, the night vision device and the illumination apparatus being activated simultaneously, and the field of view of the night vision device and the illumination field of the illumination apparatus overlapping.

### BRIEF DESCRIPTION OF THE DRAWINGS

Further features, advantages and actions of the invention emerge from the following description of preferred exemplary embodiments of the invention and from the attached figures, in which:

FIG. 1 shows a diagrammatic sketch of an interior, for example a cockpit of an aircraft, with an illumination apparatus, as an exemplary embodiment of the invention;

FIG. 2 shows a graph for illustrating the spectral properties of the illumination apparatus in FIG. 1; and

FIG. 3 shows an illustration, similar to FIG. 2, of a second exemplary embodiment for the spectral properties.

### DETAILED DESCRIPTION OF THE INVENTION

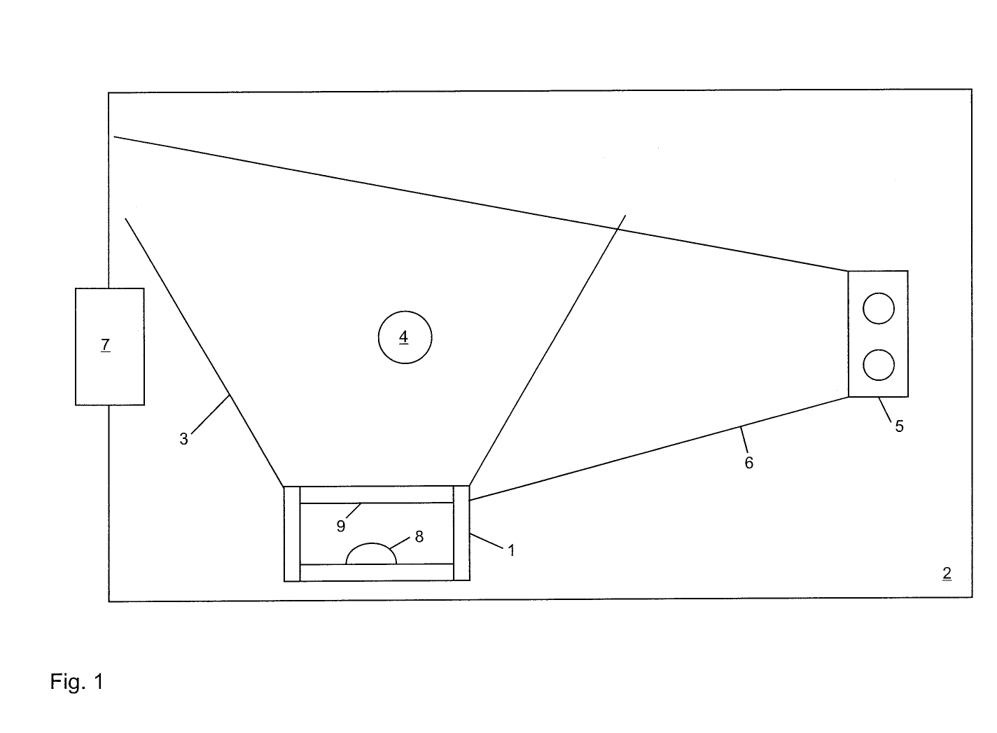

FIG. 1 shows a diagrammatic sketch of an illumination apparatus 1 as an exemplary embodiment of the invention. The illumination apparatus 1 is arranged in a cockpit 2 of an aircraft, and has an illumination field 3 in which any desired object 4 is arranged. Also located in the cockpit 2 is a night vision device 5 whose field of view 6 is aligned so that the latter acquires the body 4 and the illumination apparatus 1. The field of view 6 of the night vision device 5 defines a monitored area in the cockpit 2, or outside the cockpit 2. In principle, the night vision device 5 is aligned so that it observes a scene 7, but in so doing acquires the body 4 and the illumination apparatus 1 more by chance.

The night vision device 5 operates in a wavelength region which is situated substantially above a limiting wavelength. In the exemplary embodiment shown, the limiting wavelength is at 610 nm, but the night vision device 5 starts to operate only from a wavelength of 630 or 650 nm. The difference between the limiting wavelength and the beginning of the operating range of the night vision device 5 constitutes a safety margin.

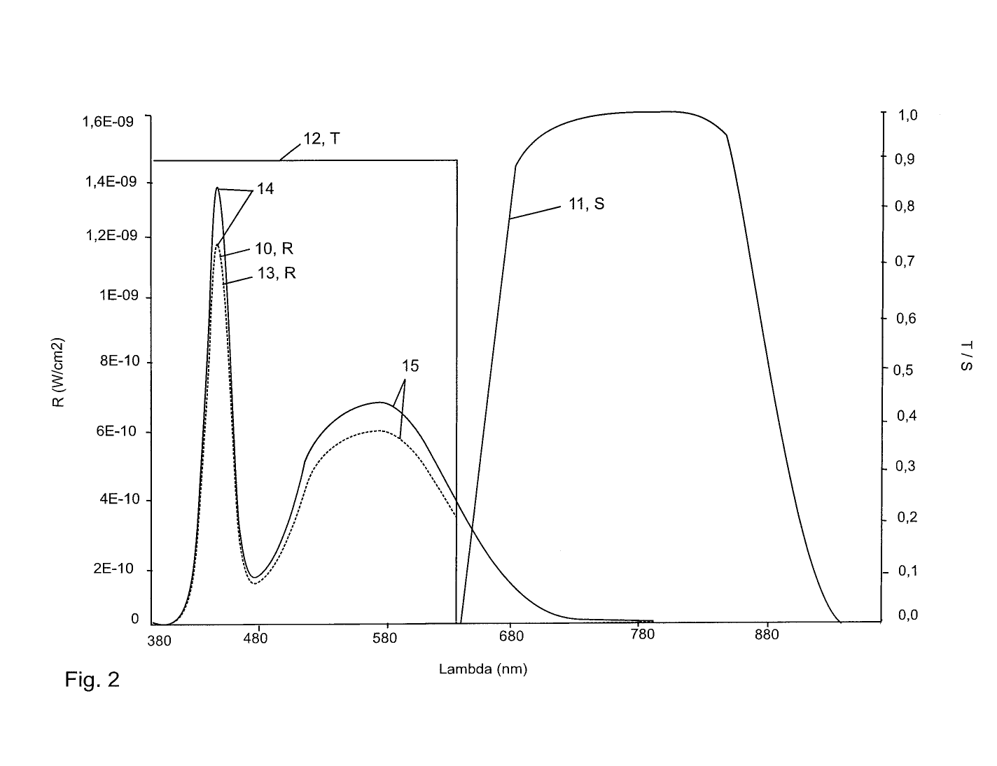

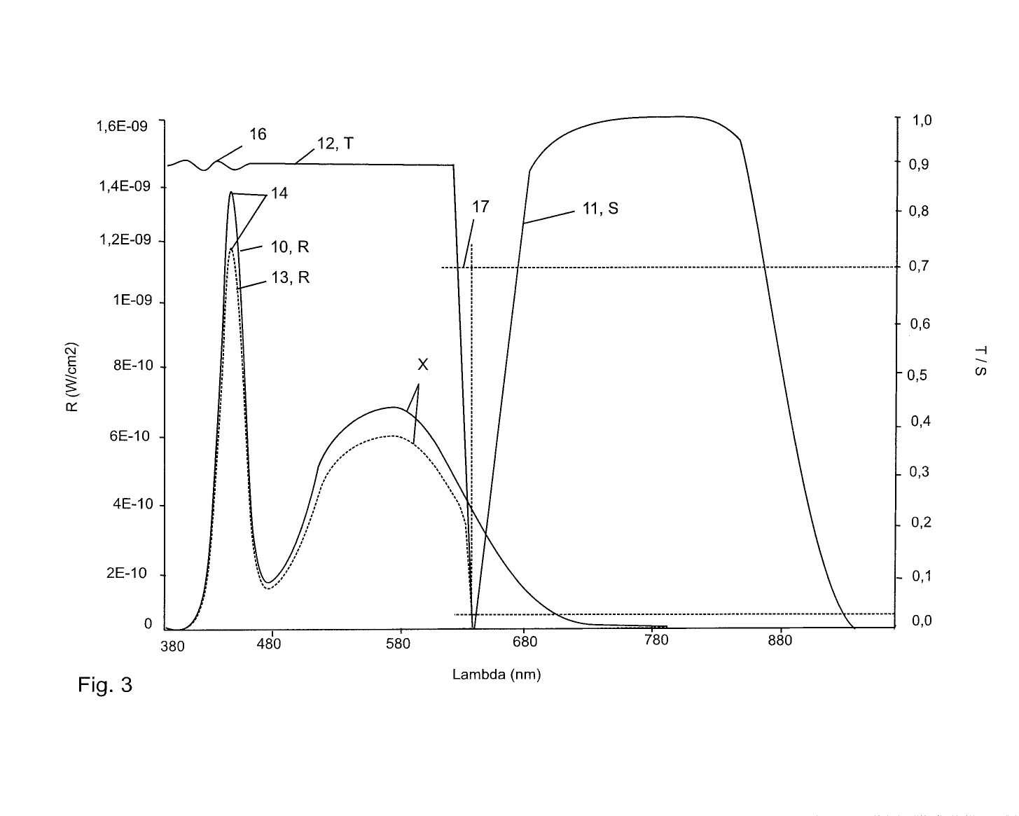

The illumination apparatus 1 comprises an illumination device which is designed in this example as a white LED 8. The spectrum of the white LED 8 is described later in conjunction with FIGS. 2 and 3. The illumination apparatus 1 further comprises an optical filter device 9 which is designed as an interference filter device. For example, the optical filter device 9 consists of a glass plate on which a plurality of dielectric layers are provided which together form a Fabry-Perot interferometer. Such interference filter devices are known and are, for example, marketed by Schott in Germany.

The dielectric short-pass filter from LOT with a limiting wavelength at 600 nm is proposed as a possible other example of a filter device which can be used. This filter is available as a catalogue item.

The overlapping of the illumination area 3 of the illumination apparatus 1 with the field of view 6 of the night vision device 5 can—(so the night vision device 5 can pick up radiation of the illumination apparatus 1)—lead to subjecting the night vision device 5 to glare. In order to avoid the glare, and for the purpose of glare-free illumination of the area on the cockpit 2, the optical filter device 9 is designed so that it does not transmit any light fractions which fall in the wavelength acquisition range of the night vision device 5.

FIG. 2 illustrates the emission spectrum 10 of the white LED 8, the sensitivity spectrum 11 of an NVIS-B night vision device in accordance with the specification MIL-STD-3009, which conforms to the sensitivity spectrum of the night vision device 5. Furthermore, the transmission curve 12 of the optical filter device 9 and the spectrum 13 of the transmitted light of the white LED according to the optical filter device 9 are illustrated.

The x-axis specifies the wavelength lambda in nm, the radiation density R in watt/cm² is plotted on the left-hand y-axis, and the transmission T of the optical filter device 9 or the relative sensitivity S of the night vision device 5, normalized respectively to 1, is plotted on the right-hand y-axis.

The emission spectrum 10, in particular the spectral distribution of the white LED 8, comprises a peak 14 in a range between 380 and 480 nm, which is adjoined by a tail section 15 from 480 nm to 780 nm. The sensitivity spectrum 11 of the night vision device 5 starts at approximately 630 nm and extends to approximately 950 nm. As follows from the illustration, the emission spectrum 10 and the sensitivity spectrum 11 overlap in the range between 630 nm (650?) and 780 nm.

For a range between 380 nm to 610 nm, the transmission curve 12 of the optical filter device shows a transmission of approximately 90% which falls back to 0% over a steep edge at 610 nm. The spectrum 13 shows the spectral distribution according to the optical filter device 9, it being evident that the height of the curve falls back by approximately 10% in the range between 380 nm and 610 nm. Given a wavelength starting from 610 nm, the curve 13 falls to the value 0, and so no light fraction is transmitted which overlaps with the sensitivity spectrum 11 of the night vision device 5.

In this way, the illumination apparatus 1 enables a glare-free illumination of a common area monitored by the night vision device 5. By contrast, a virtually normal illumination is enabled in the visible region below the limiting wavelength of 610 nm, and so users without a night vision device 5 obtain a true colour reproduction of the area and, in particular, of the cockpit 2.

It may be pointed out that the result of using the interference filter device as optical filter device 9 is to achieve the high colour fidelity and the high efficiency of the illumination apparatus 1 in conjunction with reliable blanking out of interfering light fractions in the spectrum of the white LED 8.

FIG. 3 shows a modification of the embodiment in FIG. 2, use having been made by contrast therewith of a more poorly tuned transmission curve 12 of the optical filter device 9. This transmission curve 13 bears, for example, ripples or harmonics 16 and, instead of a vertical edge, has a limiting wavelength band 17 which has a width of 20 nm. The advantages of the invention are also to be used with such a transmission curve 12, since here, as well, it is ensured that the night vision device 5 is not subjected to glare.

### REFERENCE SYMBOLS

1. Illumination apparatus
2. Cockpit
3. Illumination field
4. Object (body)
5. Night vision device
6. Field of view
7. Scene
8. White LED
9. Optical filter device
10. Emission spectrum
11. Sensitivity spectrum
12. Transmission curve
13. Spectrum
14. Peak
15. Tail section
16. Ripple or harmonics
17. Limiting wavelength band

What is claimed is:

1. An illumination apparatus for glare-free illumination of an area monitored by a night vision device, the night vision device picking up light of wavelength greater than a limiting wavelength,
having an illumination device which comprises at least one LED, the illumination device being designed to emit light with light fractions in the visible region,
wherein
an optical filter device which is designed as an interference filter device, a transmission (T) of the optical filter device being greater, in a visible wavelength region below the limiting wavelength, than 80% for the light of the illumination device in the visible wavelength region, and being less, in a red wavelength region above the limiting wavelength, than 1% for the light of the illumination device in the red wavelength region.

2. The illumination apparatus according to claim 1, wherein the transmission (T) of the optical filter device being greater than 90% for the light of the illumination device in the visible wavelength region, and being less that 0.1% for the light of the illumination device in the red wavelength region.

3. The illumination apparatus according to claim 1, wherein the optical filter device is designed as a short-pass filter and/or edge filter and/or dichroic mirror.

4. The illumination apparatus according to claim 1, wherein the limiting wavelength lies in a range between 600 nm and 650 nm.

5. The illumination apparatus according to claim 1, wherein the limiting wavelength is 610 nm.

6. The illumination apparatus according to claim 1, wherein the optical filter device has a limiting wavelength band in which the transmission (T) varies, the limiting wavelength band being designed to be narrower than 20 nm.

7. The illumination apparatus according to claim 6, wherein the limiting wavelength band is designed to be narrower than 10 nm.

8. The illumination apparatus according to claim 1, wherein the transmission (T) of the optical filter device is always greater, in the visible wavelength region below the limiting wavelength or the limiting wavelength band, than 70%.

9. The illumination apparatus according to claim 8, wherein the transmission (T) of the optical filter device is always greater, in the visible wavelength region below the limiting wavelength or the limiting wavelength band, than 80%.

10. The illumination apparatus according to claim 1, wherein the transmission (T) of the optical filter device is always less, in the red wavelength region above the limiting wavelength or the limiting wavelength band, than 2%.

11. The illumination apparatus according to claim 10, wherein the transmission (T) of the optical filter device is always less, in the red wavelength region above the limiting wavelength or the limiting wavelength band, than 0.2%.

12. The illumination apparatus according to claim 1, wherein the at least one LED is designed as a white LED.

13. The illumination apparatus according to claim 12, wherein more than 60% of the light output of the white LED is smaller, within a wavelength region, than the limiting wavelength or smaller than the limiting wavelength band, and/or less than 30% of the light output of the LED is within a wavelength region greater than the limiting wavelength or greater than the limiting wavelength band.

14. The illumination apparatus according to claim 1, wherein the illumination device has a plurality of LEDs of different colours.

15. The illumination apparatus according to claim 14, wherein the illumination device has a green, a red and a white LED, which jointly emit the light with the colour components in the visible region.

16. The illumination apparatus according claim 1, wherein the illumination apparatus is arranged in the area monitored by the night vision device.

17. A method for glare-free illumination of an area monitored by a night vision device, comprising at least partially illuminating the area monitored by the night vision device by an illumination apparatus according to claim 1.

18. An arrangement comprising a night vision device and an illumination apparatus according to claim 1, wherein the night vision device and the illumination apparatus are activated simultaneously.
